(19) United States
(12) Patent Application Publication
(10) Pub. No.: US 2026/0203002 A1
(43) Pub. Date: Jul. 16, 2026

(54) PRINT LAYOUT GENERATION APPARATUS, STORAGE MEDIUM, AND IMAGE FORMING APPARATUS

(71) Applicant: Konica Minolta, Inc., Tokyo (JP)

(72) Inventor: Yuki YAMAUCHI, Tokyo (JP)

(21) Appl. No.: 19/384,589

(22) Filed: Nov. 10, 2025

(30) Foreign Application Priority Data
Nov. 20, 2024 (JP) 2024-202117

(51) Int. Cl. G06F 3/12; G03G 15/00

(52) U.S. Cl. CPC G06F 3/1252; G03G 15/5095; G03G 15/6582; G03G 15/6588; G06F 3/1204; G06F 3/1208; G06F 3/1254; G03G 2215/00472; G03G 2215/00814

(57) ABSTRACT

To provide a print layout generation apparatus capable of preventing or suppressing an increase in effort and occurrence of errors in work such as sorting and collating of printed sheets. The print layout generation apparatus includes a hardware processor. The hardware processor acquires a plurality of print jobs, and analyzes the plurality of print jobs to acquire the number of print pages of each of the print jobs. The hardware processor is capable of imposing images of the print jobs along a first direction of one sheet and a second direction orthogonal to the first direction, and imposes the images of the print jobs that differ per column along the first direction of the one sheet, side by side in a plurality of lines along the second direction, based on the number of print pages of each of the print jobs.

### CROSS-REFERENCE TO RELATED APPLICATION

Japanese patent application No. 2024-202117 filed on Nov. 20, 2024, including description, claims, drawings, and abstract the entire disclosure is incorporated herein by reference in its entirety.

### BACKGROUND OF THE INVENTION

### 1. Technical Field

The present invention relates to a print layout generation apparatus, a storage medium, and an image forming apparatus.

### 2. Description of Related Art

In recent years, printing services that accept orders for printing cards such as postcards and business cards and carry out the printing on behalf of clients have become popular. In print shops that provide such printing services, in addition to main bodies of image forming apparatuses that form images on sheets, post-processing devices such as automatic cutting apparatuses that process sheets into the size of a postcard or a card, and sheet stacking apparatuses that stack a plurality of cut sheets are also used.

For example, as the sheet stacking apparatuses, cut-sheet stacking apparatuses that stack sheets cut into a plurality of pieces in parallel in the sheet conveyance direction is known. In the sheet stacking apparatuses, a plurality of cut sheets is conveyed in parallel and stacked in predetermined stack sections provided in the sheet ejection trays.

In this regard, a technique is known in which, when consecutive jobs are printed, sorting sheet region data is inserted at the boundary positions between a plurality of image groups, based on information on cutting and post-processing information on the stacking order of the respective sheets obtained by cutting (for example, Japanese Unexamined Patent Application Publication No. 2018-15960). In addition, a control technique that enables continuous imposition by filling in blank pages occurring between print jobs when a plurality of print jobs is printed continuously is known (for example, Japanese Unexamined Patent Application Publication No. 2019-198991).

### SUMMARY OF THE INVENTION

However, in a case where a plurality of images included in the same print job is imposed straddling a plurality of columns and the printed sheets are cut along each column, a user needs to perform work such as sorting and collating while checking the images on the printed sheets cut into the plurality columns. As a result, issues such as an increase in effort and errors in work such as sorting and collating may occur.

The present invention has been made in view of the above-mentioned circumstances. An object of the present invention is to provide a print layout generation apparatus, a computer-readable storage medium storing a print layout generation program, and an image forming apparatus capable of preventing or suppressing an increase in effort and occurrence of errors in work such as sorting and collating of printed sheets.

To achieve at least one of the abovementioned objects, according to an aspect of the present invention, an image inspection apparatus reflecting one aspect of the present invention comprises the followings.

A print layout generation apparatus includes a hardware processor. The hardware processor acquires a plurality of print jobs, and analyzes the plurality of print jobs to acquire the number of print pages of each of the print jobs. The hardware processor is capable of imposing images of the print jobs along a first direction of one sheet and a second direction orthogonal to the first direction, and imposes the images of the print jobs side by side in a plurality of lines along the second direction of the one sheet. The hardware processor imposes the images of the print jobs that differ per column based on the number of print pages of each of the print jobs.

### BRIEF DESCRIPTION OF THE DRAWINGS

Although, advantages and features provided by one or more embodiments of the present invention will be fully understood in conjunction with the following detailed description and the accompanying drawings, these are for purposes of example only and are not intended as a definition of the limits of the present invention.

FIG. 1 is a diagram illustrating a schematic configuration of an image forming system according to an embodiment;

FIG. 2 is a schematic block diagram illustrating a configuration of an image forming apparatus illustrated in FIG. 1;

FIG. 3 is a schematic block diagram illustrating a configuration of a controller illustrated in FIG. 2;

FIG. 4 is a schematic cross-sectional view illustrating a configuration of a sheet processing apparatus and the sheet ejection device illustrated in FIG. 1;

FIG. 5 is a perspective view illustrating a schematic configuration of the sheet ejection device illustrated in FIG. 4;

FIG. 6 is a functional block diagram illustrating main functions of a print layout generation apparatus;

FIG. 7 is a flowchart illustrating a processing procedure of a print layout generation method executed by the print layout generation apparatus;

FIG. 8 is a subroutine flowchart illustrating details of a process of step S102 in FIG. 7;

FIG. 9 is a subroutine flowchart illustrating details of a process of step S103 in FIG. 7;

FIG. 10 is a schematic diagram illustrating an example of an imposition layout per sheet;

FIG. 11 is a subroutine flowchart illustrating details of a process of step S106 in FIG. 7;

FIG. 12 is a table summarizing the number of print pages (A), the number of partition pages (B), and the required number of pages (C) for each job;

FIG. 13 is a schematic diagram illustrating print layouts generated by the print layout generation apparatus;

FIG. 14 is a schematic diagram illustrating another example of an imposition layout per sheet;

FIG. 15 is a table summarizing the number of print pages (A), the number of partition pages (B), and the required number of pages (C) for each job;

FIG. 16 is a schematic diagram illustrating print layouts generated by the print layout generation apparatus;

FIG. 17 is a table summarizing the number of print pages (A), the number of partition pages (B), and the required number of pages (C) for each job; and

FIG. 18 is a schematic diagram illustrating print layouts generated by the print layout generation apparatus.

### DETAILED DESCRIPTION

Hereinafter, an embodiment of the present invention will be described with reference to the drawings. However, the scope of the present invention is not limited to the disclosed embodiment. Note that in the description of the drawings, the same components are denoted by the same reference signs, and redundant descriptions are omitted. In addition, dimensional ratios in the drawings are exaggerated for convenience of explanation and may be different from actual ratios.

### Image Forming System 100

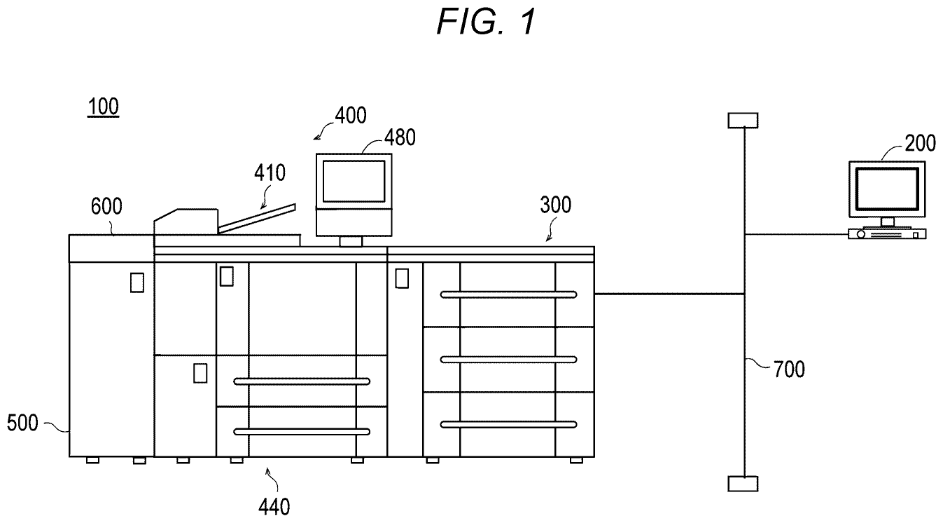

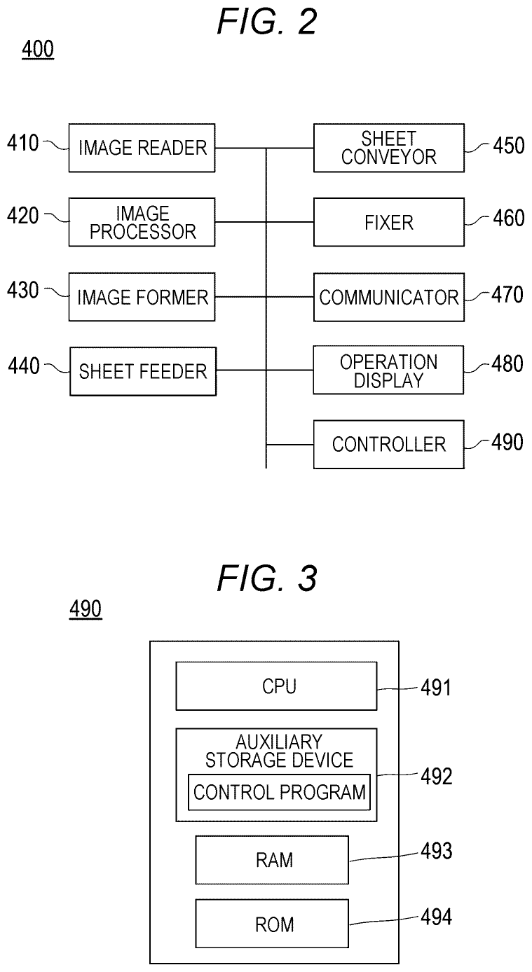

FIG. 1 is a diagram illustrating a schematic configuration of an image forming system 100 according to an embodiment of the present invention, FIG. 2 is a schematic block diagram illustrating a configuration of an image forming apparatus 400 illustrated in FIG. 1, and FIG. 3 is a schematic block diagram illustrating a configuration of a controller 490 illustrated in FIG. 2.

As illustrated in FIG. 1, the image forming system 100 includes a client terminal 200, a sheet feed device 300, an image forming apparatus 400, a sheet processing apparatus 500, and a sheet ejection device 600. The client terminal 200, the sheet feed device 300, the image forming apparatus 400, the sheet processing apparatus 500, and the sheet ejection device 600 are communicably connected to each other via a communication line 700 or the like.

### Client Terminal 200

The client terminal 200 may be, for example, a personal computer, a tablet terminal, a smartphone, or the like. A printer driver for converting document data into a print job is installed in the client terminal 200. Hereinafter, a print job is also simply referred to as a “job”. The printer driver generates a job in a format compatible with the controller 490 (see FIGS. 2 and 3) of the image forming apparatus, and transmits the job to the image forming apparatus 400 via the communication line 700. In addition, the client terminal 200 includes a display and can display a layout of a print image. The layout of the print image is also referred to as a “print layout”.

The job includes, for example, print data in a page description language (PDL) format and job information. The print data includes, for example, print data of the first to n-th pages. The job information includes, for example, information on sheets and images such as the number of pages, the number of copies, the type, size and basis weight of the sheet, and image size, and print settings such as single-sided printing/double-sided printing.

The communication line 700 may include a local area network (LAN) in which computers and network devices are connected to each other according to a predetermined standard, a wide area network (WAN) in which LANs are connected to each other via a dedicated line, or the like. The predetermined standard is, for example, Ethernet (registered trademark), fiber distributed data interface (FDDI), wireless fidelity (Wi-Fi), or the like.

Note that the number of the above constituent elements connected to the communication line 700 is not limited to the case illustrated in FIG. 1.

### Sheet Feed Device 300

The sheet feed device 300 includes at least one large-capacity sheet tray, and supplies sheets one by one to the image forming apparatus 400.

### Image Forming Apparatus 400

The image forming apparatus 400 reads an image from a document, and forms (prints) the read image on a sheet. In addition, the image forming apparatus 400 receives a job including the print data in the PDL format and the print setting data from the client terminal 200 via the communication line 700, and forms an image on a sheet based on the job.

As illustrated in FIG. 2, the image forming apparatus 400 includes an image reader 410, an image processor 420, an image former 430, a sheet feeder 440, a sheet conveyor 450, a fixer 460, a communicator 470, an operation display 480, and the controller 490. These constituent elements are communicably connected to each other via an internal bus.

### [Image Reader 410]

The image reader 410 includes an optical system including a mirror, a lens and the like, and a reading sensor. The image reader 410 reads a document placed on a reading surface or a document conveyed by an auto document feeder (ADF), to output an image signal.

### [Image Processor 420]

The image processor 420 performs various kinds of image processing on the image signal received from the image reader 410, to generate print image data. In addition, the image processor 420 generates the print image data based on the print setting information and the print data included in the job received by the communicator 470. The generated print image data is transmitted to the image former 430.

### [Image Former 430]

The image former 430 forms an image on a sheet based on the print image data, through a known image forming process such as an electrophotographic method including steps of charging, exposing, developing, and transferring. The image former 430 includes a photosensitive drum as an image bearing member, and a charger, an optical writer, a developing device, and a transferer that are arranged around the photosensitive drum.

The photosensitive drum is rotated at a predetermined speed by a drum motor (not illustrated). The charger includes a corona discharge electrode arranged around the photosensitive drum, and charges the surface of the photosensitive drum with generated ions. The optical writer incorporates a scanning optical device, and exposes the charged photosensitive drum based on the input print image data to reduce the potential of the exposed portion, thereby forming a charge pattern (electrostatic latent image) corresponding to the print image data. The developing device develops the formed electrostatic latent image and visualizes it with toner to form a toner image. The transferer transfers the toner image on the photosensitive drum onto a sheet.

### [Sheet Feeder 440]

The sheet feeder 440 supplies a sheet as a recording material to the image former 430. The sheet feeder 440 includes an upper tray and a lower tray, and the trays can store, for example, sheets of different sizes such as A4 and A3 sizes.

### [Sheet Conveyor 450]

The sheet conveyor 450 conveys a sheet in the image forming apparatus 400. The sheet conveyor 450 includes a conveyance path and a plurality of conveyance roller pairs. In addition, the sheet conveyor 450 includes a sheet reverser and a circulation conveyor, and is capable of reversing the front and back sides of a sheet and ejecting it, or of forming images on both sides of the sheet.

The sheet fed from the sheet feed device 300 or the sheet feeder 440 is conveyed through the conveyance path toward the image former 430. The sheet is synchronized with the toner image formed on the photosensitive drum at a registration roller pair, and timing at which the sheet is conveyed to the transferer is controlled. The sheet on which the toner image has been transferred by the transferer is conveyed to the fixer 460.

### [Fixer 460]

The fixer 460 fixes the toner image formed on the sheet. The fixer 460 includes a hollow heating roller inside which a heater is arranged and a pressure roller opposed to the heating roller. The heating roller and the pressure roller are controlled to be at a predetermined temperature (for example, 160° C. or more) by the heater, and apply heat and pressure to the sheet to fix the toner image thereto. The sheet to which an image has been fixed is supplied to the sheet processing apparatus 500 through a sheet ejector (not illustrated).

### [Communicator 470]

The communicator 470 is connected to, for example, the client terminal 200 via the communication line 700, and transmits and receives data such as jobs.

### [Operation Display 480]

The operation display 480 includes an input section and an output section. The input section includes, for example, a keyboard and a touch screen, and is used for a user to perform various kinds of instructions (inputs) such as character input, various kinds of settings, and a start instruction. In addition, the output section includes a display, and is used to present, to the user, a device configuration, an execution status of a job, conditions under which post-processing can be performed, an output image, an occurrence status of an abnormality (jam) in sheet conveyance, and the like.

[controller 490]

The controller 490 controls the image reader 410, the image processor 420, the image former 430, the sheet feeder 440, the sheet conveyor 450, the fixer 460, the communicator 470, and the operation display 480. As illustrated in FIG. 3, the controller 490 includes a CPU 491, an auxiliary storage device 492, a RAM 493, and a ROM 494.

The CPU 491 executes a control program for the image forming apparatus. The control program is stored in the auxiliary storage device 492 and is loaded into the RAM 493 when executed by the CPU 491. The auxiliary storage device 492 includes, for example, a large-capacity storage device such as a hard disk drive and a flash memory. The RAM 493 stores calculation results associated with the execution of the CPU 491, positions and types of functional units loaded in the sheet processing apparatus 500, prohibition condition information and the like. The ROM 494 stores various kinds of parameters, various kinds of programs, and the like. The CPU 491 executes the control program to implement various functions.

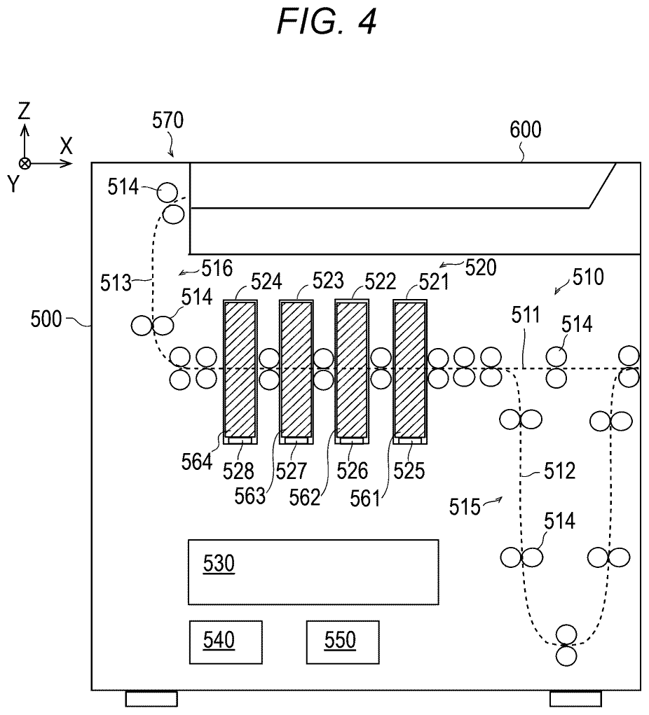

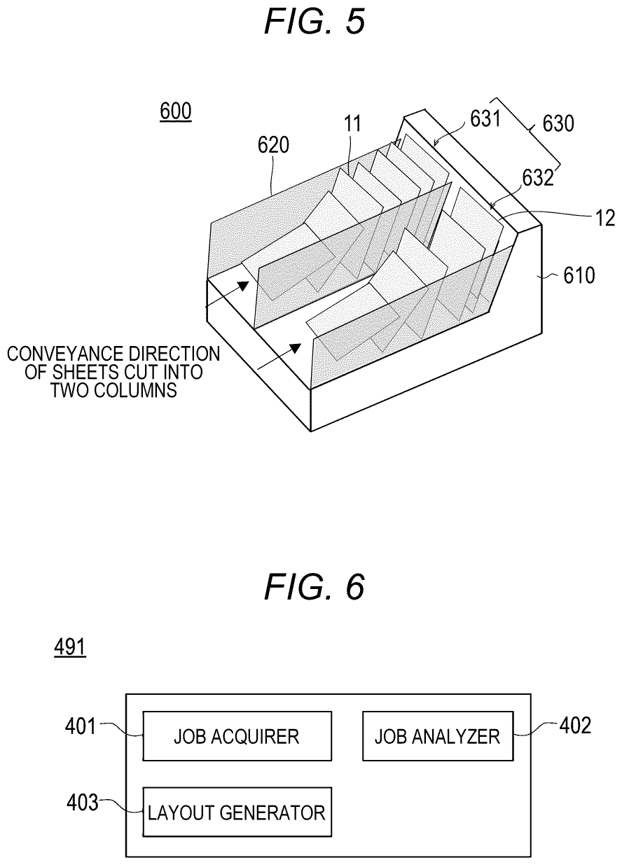

Furthermore, in the present embodiment, the CPU 491 executes the print layout generation program, and thereby functions as the print layout generation apparatus. The print layout generation program is also stored in the auxiliary storage device 492 and is loaded into the RAM 493 when executed by the CPU 491. The print layout generation apparatus according to the present embodiment includes a function of imposing images of a job side by side in a plurality of lines along a direction orthogonal to a conveyance direction of a sheet to be cut by a processing processor 520 (see FIG. 4) to be described below. Then, the images imposed side by side in the plurality of lines by the print layout generation apparatus are printed on a sheet by the image former 430, and the sheet is cut into the plurality of lines along the images by the processing processor 520 and then conveyed side by side to the sheet ejection device 600 to be stacked in the plurality of columns (see FIG. 5). Details of functions of the print layout generation apparatus will be described below.

### Sheet Processing Apparatus 500

FIG. 4 is a schematic cross-sectional view illustrating a configuration of the sheet processing apparatus 500 and the sheet ejection device 600 illustrated in FIG. 1. In the drawings, a top-bottom direction (vertical direction) is defined as a Z direction, a front-to-rear direction of the sheet processing apparatus 500 and the sheet ejection device 600 is defined as a Y direction, and a direction orthogonal to the Y and Z directions is defined as an X direction. The Y direction is also referred to as a sheet width direction.

The sheet processing apparatus 500 conveys or processes a sheet supplied from the image forming apparatus 400 according to an instruction from the image forming apparatus 400, and supplies the sheet to the sheet ejection device 600.

As illustrated in FIG. 4, the sheet processing apparatus 500 includes a sheet conveyor 510, the processing processor 520, a waste box 530, a communicator 540, and a controller 550. These constituent elements are communicably connected to each other via an internal bus.

[sheet Conveyor 510]

The sheet conveyor 510 includes conveyance paths 511, 512, and 513 and a plurality of conveyance roller pairs 514, and conveys the sheet supplied from the image forming apparatus 400 along the sheet conveyance paths 511, 512, and 513.

The sheet conveyor 510 also includes a long sheet conveyor 515 and an ejection conveyor 516. The long sheet conveyor 515 aligns a long sheet supplied from the image forming apparatus 400 while conveying the long sheet. More specifically, the long sheet conveyor 515 temporarily holds the long sheet supplied from the image forming apparatus 400 in the conveyance path 512, and aligns the sheet in terms of inclination with respect to the conveyance direction and the like (adjusts the sheet to correct orientation) before conveying the sheet to the processing processor 520. In addition, the ejection conveyor 516 conveys the sheet from the processing processor 520 to the sheet ejection device 600. Note that although the illustration is simplified, the ejection conveyor 516 may include a large number of the conveyance roller pairs 514 along the conveyance path 513 to reliably convey the sheets that have been cut into a postcard size or a business card size by the processing processor 520.

Each of the conveyance roller pairs 514 of the ejection conveyor 516 includes a plurality of sets of conveyance roller pairs arranged along the sheet width direction. Thus, each conveyance roller pair 514 is capable of independently conveying each of the sheets cut into a plurality of columns along the sheet width direction. For example, the conveyance roller pairs 514 each include two sets of conveyance roller pairs arranged side by side along the sheet width direction, and each of the conveyance roller pairs 514 is capable of independently conveying each of the sheets cut into two columns along the sheet width direction.

### [Processing Processor 520]

The processing processor 520 functions as a processing section and performs processing on a sheet by one or more functional units. The processing processor 520 includes a plurality of slots 521 to 524 for loading the functional units. The slots 521 to 524 have slot numbers (#1 to #4), respectively, and each slot is loaded with a functional unit at a corresponding loading position along the conveyance path. The loading position is defined by a position on the conveyance path (position in the X direction). FIG. 4 illustrates a case where functional units 561 to 564 are loaded in the slots 521 to 524, respectively. Although prohibition conditions exist, each of the functional units 561 to 564 can be loaded into any of the slots 521 to 524 and can be replaced with each other. In addition, it is not necessary to load the functional units 561 to 564 into all of the slots 521 to 524, and only some of the slots 521 to 524 may be loaded. When the slots 521 to 524 are empty, dummy units are loaded in such a manner as not to interfere with sheet conveyance.

In addition, detection sensors 525 to 528 are installed in the slots 521 to 524, respectively. The detection sensors 525 to 528 cooperate with the controller 490 to determine the presence or absence of loading of each of the functional units 561 to 564. Furthermore, when the functional units are loaded in the slots 521 to 524, the detection sensors 525 to 528 acquire information on the types of the functional units and the presence or absence of loading, that is, the loading positions, of the functional units.

The detection sensors 525 to 528 each may have any form as long as the sensor can detect the presence or absence of loading of the functional unit and the type of the functional unit, and for example, an optical sensor, an actuator, or the like can be used for the sensor. Alternatively, a configuration may be employed in which the controller 490 detects the presence or absence of the loading by engaging and electrically connecting a connector on the side of the main body of the sheet processing apparatus 500 and a connector of the functional unit to each other, and after the connection, the controller 490 detects (determines) the type of the functional unit by reading the identification number stored in the control board of the functional unit.

The functional units 561 to 564 may be, for example, any of a CD cutting unit, a top/bottom slit (FD cutting) unit, a gutter cutting slit unit, a crease unit, a CD perforation unit, an FD perforation unit, and a business card slit unit. The term “CD” means “Cross Direction” and the term “FD” means “Feed Direction”. In addition, the term “gutter” refers to a margin provided outside from a finishing position between adjacent images in a sheet to be cut, in consideration of misalignment during cutting. The term “gutter cutting” refers to cutting off the gutter during cutting.

The CD cutting unit refers to a unit that cuts a sheet along the CD direction. In addition, the top/bottom slit unit refers to a unit that cuts a sheet along the sheet conveyance direction, and is also referred to as FD cutting unit. The top/bottom slit may be a slitter that cuts a sheet by rubbing an upper rotary blade and a lower rotary blade against each other. Hereinafter, the sheet conveyance direction is also referred to as “FD direction” and the direction orthogonal to the sheet conveyance direction is also referred to as “CD direction”.

The gutter cutting slit unit refers to a unit that forms a slit along the FD direction. For example, in the gutter cutting slit processing, cutting is performed along two parallel cutting lines, with a slit (groove) formed between the two cutting lines. The crease unit refers to a unit that forms a crease along a predetermined direction, for example, the CD direction.

The CD perforation unit refers to a unit that forms a perforation along the CD direction, and the FD perforation unit refers to a unit that forms a perforation along the FD direction. The business card slit unit refers to a unit that forms a plurality of slits along the FD direction to cut a sheet in a business card size. Note that the processing processor 520 may use functional units other than those described above.

The sheet processed by the processing processor 520 is ejected to the sheet ejection device 600 through the conveyance roller pairs 514 of the ejection conveyor 516.

### [Waste Box 530]

Cutting waste obtained by cutting by the functional units that performs sheet cutting falls into the waste box 530 by its own weight and is accumulated therein. The user periodically empties the cutting waste in the waste box 530.

### [Communicator 540]

The communicator 540 is communicably connected to the image forming apparatus 400 via the communication line 700, and transmits and receives data.

### [Controller 550]

The controller 550 controls the sheet conveyor 510, the processing processor 520, and the communicator 540. The controller 550 includes a CPU, a RAM, and a ROM.

The controller 550 executes the control program for the sheet processing apparatus to implement various functions. The RAM stores calculation results and processing results of the CPU, the positions and types of the functional units loaded in the processing processor 520, prohibition condition information, and the like. The ROM stores the control program, various kinds of parameters including the loading positions (positions on the conveyance path) corresponding to the slots (or slot numbers), and the like.

### [Sheet Ejection Device 600]

FIG. 5 is a perspective view illustrating a schematic configuration of the sheet ejection device 600 illustrated in FIG. 4. The plurality of sheets cut along the column direction by the processing processor 520 is conveyed to the sheet ejection device 600. In the present embodiment, the column direction of a sheet coincides with the FD direction along which the sheet is cut by the processing processor 520, for example. The sheet ejection device 600 stacks the plurality of conveyed sheets in parallel. The sheet ejection device 600 includes a stopper 610 that stops the conveyed sheets and a plurality of separators 620 that partitions the respective columns, and the sheets are stacked in a space formed between the stopper 610 and the plurality of separators 620. FIG. 5 illustrates a configuration of the stack section 630 that stacks, in parallel, a first sheet 11 and a second sheet 12 conveyed in parallel in two columns. The stack section 630 includes a first stack section 631 corresponding to a first column and a second stack section 632 corresponding to a second column. The user picks up the sheets stacked in the stack section 630 for each column, and performs sorting work. Note that similarly in a case of stacking three or more sheets in parallel, the sheet ejection device may include stack sections corresponding to the respective columns partitioned by the separators.

### Example of Imposition Control

In the present embodiment, it is possible to impose images of a job along the column direction of one sheet and the row direction orthogonal to the column direction. In a case of a plurality of jobs, it is possible to impose images of the jobs side by side in a plurality of lines along the column direction and/or the row direction. Each column imposed on a sheet is also referred to as an output column. In a case where the number of print pages of a job is large, imposition of the images is performed sequentially on a plurality of consecutive sheets. The number of print pages corresponds to the number of images (pages) to be printed included in the job.

In sorting and collating the printed sheets, it is preferable to impose such that the images of the same job do not straddle the output columns, that is, the output columns are assigned to each job, from the viewpoint of suppressing an increase in effort and occurrence of errors in work. For example, when a plurality of jobs including a job 1 is output in two columns, it is preferable that all images of the job 1 be imposed on one column, and that images of a job different from the job 1 be imposed on the other column.

Furthermore, from the viewpoint of cost in addition to the above-described viewpoint, it is preferable that the plurality of jobs be imposed on as few sheets as possible.

As described below with a specific example, depending on the number of jobs, the number of print pages in each job, and the number of output columns, there may be a case where imposition on the expected number of sheets can be achieved without straddling the output columns and a case where imposition on the expected number of sheets cannot be achieved without straddling the output columns. The expected number of sheets may be calculated by, for example, dividing the total number of pages by the number of impositions per sheet.

For example, the print layout generation apparatus of the present embodiment is capable of performing imposition control in accordance with the following items 1 to 5.
1. The print layout generation apparatus acquires the size of sheets to be printed, the size of images, a condition (imposition constraint condition) based on the processing by the processing processor 520, and the number of output columns that can be accepted in the sheet ejection device 600, to determine the number of pages that can be imposed on a sheet.
2. The total number of print pages for a plurality of jobs to be consecutively printed is acquired, and imposition is performed with priority given to arrangements in which images of the same job do not straddle the output columns as much as possible, based on the number of pages that can be imposed that has been determined in the above item 1 and the number of output columns.
3. A configuration may be employed in which a partition page for identification is automatically inserted before or after each job.
4. A configuration may be employed in which a blank page is automatically inserted between jobs to prevent straddling the output columns.
5. A configuration may be employed in which in the case where imposition on the expected number of sheets cannot be achieved without straddling the output columns, control may be performed such that imposition is performed without straddling the output columns up to the allowable number of blank pages, and imposition is performed with straddling the output columns for a case of the number of blank pages equal to or larger than the allowable number of blank pages, according to the selection by the user.

### Print Layout Generation Method

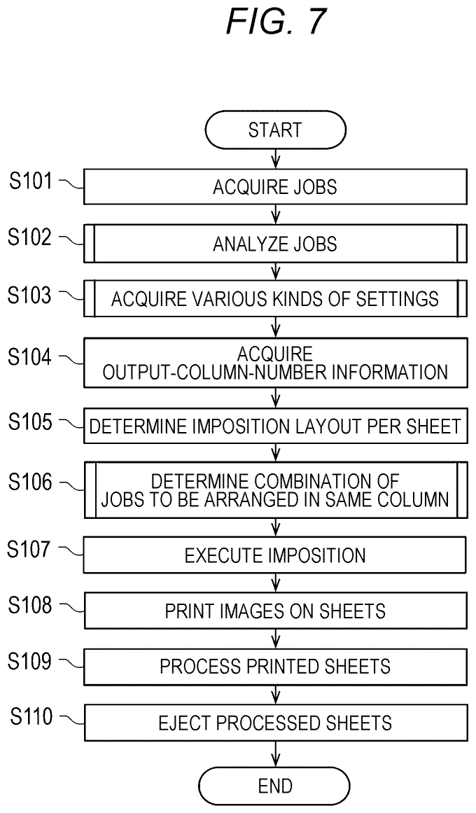

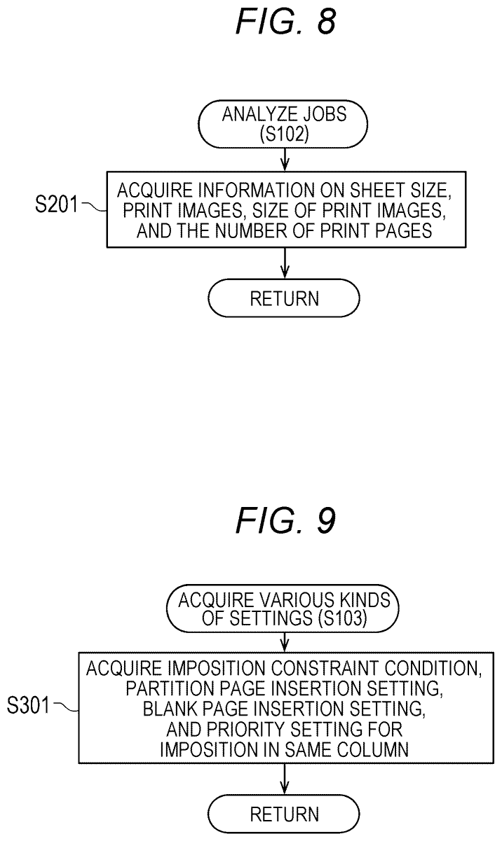

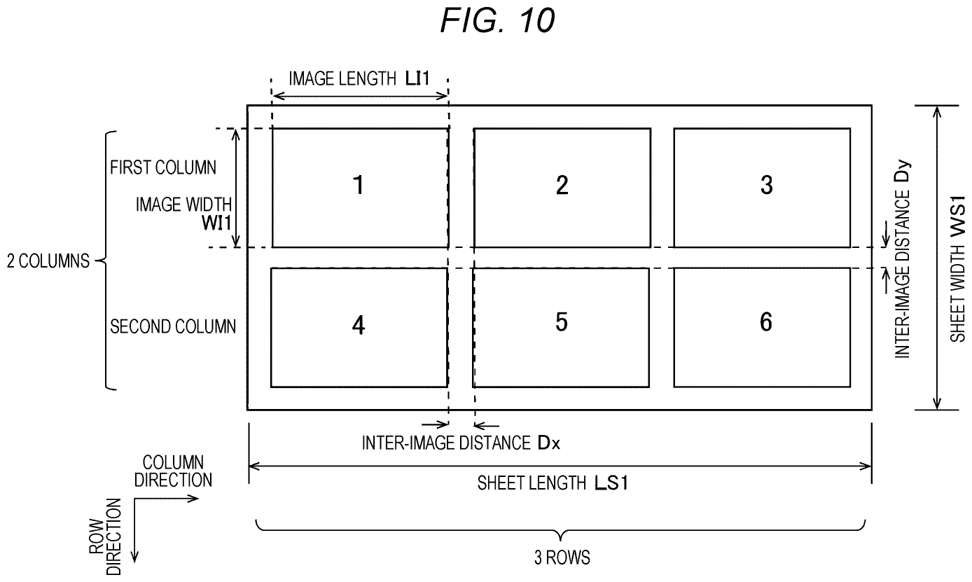

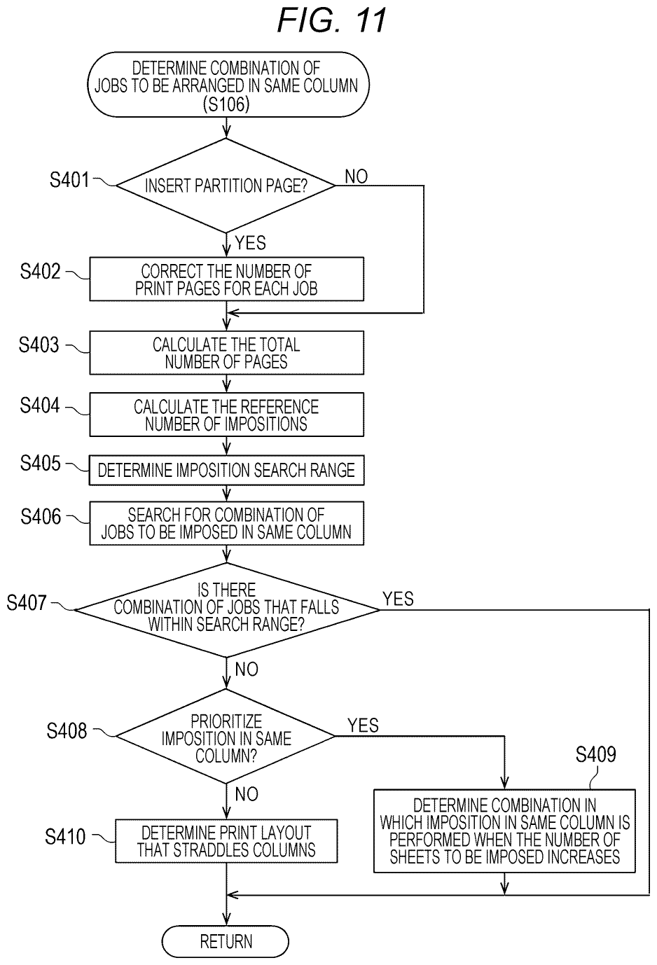

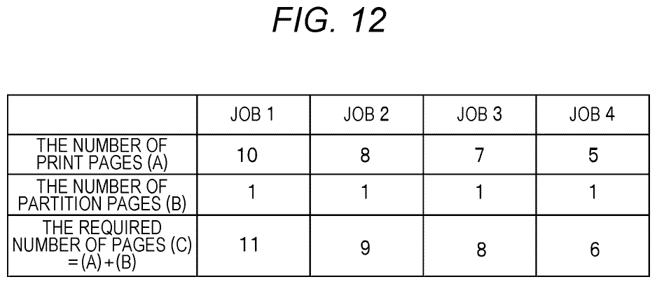

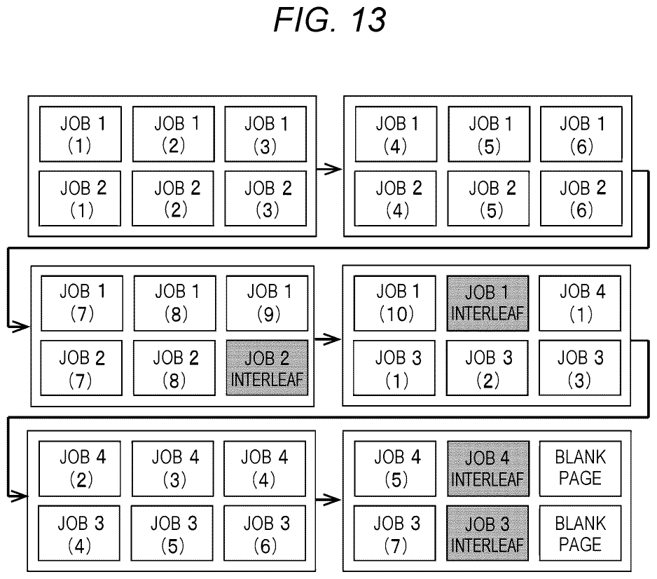

FIG. 6 is a functional block diagram illustrating main functions of the print layout generation apparatus, and FIG. 7 is a flowchart illustrating a processing procedure of a print layout generation method executed by the print layout generation apparatus. In addition, FIG. 8 is a subroutine flowchart illustrating details of a process of step S102 in FIG. 7, and FIG. 9 is a subroutine flowchart illustrating details of a process of step S103 in FIG. 7. The functions in the functional block diagram of the print layout generation apparatus illustrated in FIG. 6 and the processes in the flowchart illustrated in FIG. 7 and the subroutine flowcharts illustrated in FIGS. 8 and 9 are implemented by the CPU 491 of the controller 490 executing the print layout generation program. FIG. 10 is a schematic diagram illustrating an example of an imposition layout per sheet; FIG. 11 is a subroutine flowchart illustrating details of a process of step S106 in FIG. 7. The process of the subroutine flowchart illustrated in FIG. 11 is implemented by the CPU 491 of the controller 490 executing the print layout generation program. FIG. 12 is a table summarizing the number of print pages (A), the number of partition pages (B), and the required number of pages (C) for each job. FIG. 13 is a schematic diagram illustrating print layouts generated by the print layout generation apparatus.

As illustrated in FIG. 6, the print layout generation apparatus includes a job acquirer 401, a job analyzer 402, and a layout generator 403. Hereinafter, each function of the print layout generation apparatus and the details of the processing procedure of the print layout generation method will be described with reference to an example of a case where images of the same job can be imposed on the expected number of sheets without straddling the output columns.

As illustrated in FIG. 7, first, the job acquirer 401 acquires jobs (step S101). The job acquirer 401 acquires, for example, four consecutive jobs of a job 1 to a job 4. Each of the job 1 to the job 4 may include a plurality of pages (images). For example, the job 1 includes 10 pages of images, the job 2 includes 8 pages of images, the job 3 includes 7 pages of images, and the job 4 includes 5 pages of images.

Next, the job analyzer 402 analyzes the jobs (step S102). As illustrated in FIG. 8, the job analyzer 402 analyzes the plurality of jobs to acquire, for example, information on the sheet size, print images, the size of the print images, and the number of print pages for each job (step S201). For example, for each of the four jobs acquired in step S101, the information on the sheet size, the print images, the size of the print images, and the number of print pages are acquired and stored in RAM 493. The sheet size may include a sheet width WS1 and a sheet length LS1. The size of the print images may include an image width WI1 and an image length LI1. The number of print pages is equal to the number of pages in each job, and thus the number of print pages of the jobs 1 to 4 are 10, 8, 7, and 5, respectively.

Next, the layout generator 403 acquires various kinds of settings (step S103). More specifically, as illustrated in FIG. 9, the layout generator 403 acquires, as the various kinds of settings, for example, the imposition constraint condition, a partition page insertion setting, a blank page insertion setting, and a priority setting for imposition in the same column and stores them in the RAM 493. The imposition constraint condition is, for example, a constraint condition related to the distance between images in the imposition on a sheet. The distance between images include, for example, an inter-image distance Dx in the column direction and an inter-image distance Dy in the row direction. The partition page insertion setting refers to the setting related to whether to insert a partition page between jobs. The partition page refers to a paper for identification that is inserted before or after each of a plurality of jobs. The blank page insertion setting refers to the setting related to whether to insert a blank page. In some cases, by inserting blank pages between jobs to increase the number of sheets to be imposed, it is possible to prevent images of the same print job from straddling a plurality of columns. The priority setting for imposition in the same column refers to the setting related to whether to prioritize the imposition in the same column even if the number of sheets increases in the case where imposition on the expected number of sheets cannot be achieved without straddling the output columns.

Next, the layout generator 403 acquires output-column-number information (step S104). The output-column-number information refers to the information related to the number of output columns. The number of output columns is, for example, stored in advance in the RAM of the controller 550, and is transmitted to the controller 490 through the communicator 470 to be stored in the RAM 493. The layout generator 403 acquires, for example, “2” as the number of output columns.

Next, the layout generator 403 determines an imposition layout per sheet (step S105). The layout generator 403 of the present embodiment is capable of imposing images of a job on a sheet along the column direction (first direction) and the row direction (second direction) orthogonal to the column direction, and of generating an imposition layout in which the images of the job are arranged side by side in a plurality of lines along the row direction.

As illustrated in FIG. 10, the layout generator 403 generates an imposition print layout per sheet based on the sheet size (WS1, LS1), the image size (WI1, LI1), the imposition constraint condition, and the number of output columns. Letting the number of pages that can be imposed per column be m, for example, the layout generator 403 calculates the number of pages that can be imposed per column m according to the following Expression (1). m is a natural number of 2 or more.

$$m = ( sheet length LS 1 - ( m - 1 ) \times inter - image distance Dx + column direction margins ) / image length LI 1 \qquad Expression ( 1 )$$

In the example illustrated in FIG. 10, the number of pages that can be imposed per column on a sheet is 3, so that a layout of images of three rows and two columns is generated. In the present embodiment, for example, the image sizes (output sizes) are all identical. The number of impositions per sheet is as follows: 3×2=6.

Next, the layout generator 403 determines a combination of jobs to be arranged in the same column (step S106). More specifically, as illustrated in FIG. 11, the layout generator 403 determines whether to insert a partition page (step S401). The layout generator 403 determines to insert the partition page in a case where the partition page insertion setting is ON, and determines not to insert the partition page in a case where the partition page insertion setting is OFF. In the case where the partition page is inserted (step S401: YES), the layout generator 403 corrects the number of print pages for each job (step S402). Specifically, as illustrated in FIG. 12, the layout generator 403 calculates, for each job, the required number of pages (C) by adding the number of partition pages (B) to the number of print pages (A). The number of print pages of the job 1 is 10, the number of print pages of the job 2 is 8, the number of print pages of the job 3 is 7, and the number of print pages of the job 4 is 5. Thus, by adding 1, which is the number of partition pages (B), to the number of print pages (A) of each job, the required number of pages of the job 1 is 11, the required number of pages of the job 2 is 9, the required number of pages of the job 3 is 8, and the required number of pages of the job 4 is 6. On the other hand, in the case where the partition page is not inserted (step S401: NO), the process advances to step S403 without correcting the number of print pages (A). in the case where the partition page is not inserted, the required number of pages (C) for each job is the same as the number of print pages (A).

Next, the layout generator 403 calculates the total number of pages (step S403). Specifically, the layout generator 403 calculates the sum of the required number of pages (C) for all the print jobs. In the example illustrated in FIG. 12, the required number of pages of the job 1 is 11, the required number of pages of the job 2 is 9, the required number of pages of the job 3 is 8, and the required number of pages of the job 4 is 6, so that the sum of the required number of pages (C) for all the print jobs, that is, the total number of pages is 34. The expected number of sheets is calculated by dividing the total number of pages by the number of impositions per sheet, as follows: 34÷6 ≈5.67. Accordingly, the expected number of sheets is 6.

Next, the layout generator 403 calculates the reference number of impositions (step S404). The layout generator 403 calculates the reference number of impositions by dividing the total number of pages by the number of output columns. In the example illustrated in FIG. 12, the total number of pages is 34 and the number of output columns is 2, so that the reference number of impositions is 17.

Next, the layout generator 403 determines an imposition search range (step S405). Since the number of pages that can be imposed per column on a sheet is 3, pages are imposed in multiples of three along each column on sheets. The layout generator 403 determines the imposition search range to be between n times 3 (that is, the 3×n-th sheet) and (n−1) times 3 (that is, the 3×(n−1)-th sheet). The reference number of impositions is 17, and the following expression holds. 3×5<17<3×6. Thus, the layout generator 403 determines the imposition search range to be 15 to 18. Here, n is a natural number.

Next, the layout generator 403 searches for a combination of jobs to be imposed in the same column (step S406). As a result of the search for a combination of jobs, the layout generator 403 determines whether or not there is a combination of jobs that falls within the search range (step S407). When a single job or a plurality of jobs is assigned to each column from among the jobs 1 to 4, the layout generator 403 determines, in all the columns, whether the required number of pages of the single job or the sum of the required number of pages for the plurality of jobs falls within the search range. Since the required number of pages of the job 1 and the job 4 are 11 and 6, respectively, the sum of the required number of pages in a case of the combination of the job 1 and the job 4 is 17. In addition, since the required number of pages of the job 2 and the job 3 are 9 and 8, respectively, the sum of the required number of pages in a case of the combination of the job 2 and the job 3 is also 17. Thus, in this case, the layout generator 403 determines that there is a combination of jobs that falls within the search range in all the columns. In a case where there is a combination of jobs that falls within the search range (step S407: YES), the layout generator 403 stores the combination of jobs that falls within the search range in the RAM, and the process ends (return).

On the other hand, in a case where there is no combination of jobs that falls within the search range (step S407: NO), the layout generator 403 determines whether to prioritize the imposition in the same column (step S408). The layout generator 403 determines to prioritize the imposition in the same column in a case where the priority setting for imposition in the same column is ON, and determines not to prioritize the imposition in the same column in a case where the priority setting for imposition in the same column is OFF. In a case where the imposition in the same column is prioritized (step S408: YES), the layout generator 403 determines a combination for imposition in the same column when the number of sheets to be imposed increases (step S409), and the process ends (return). An increase in the number of sheets is achieved by inserting blank pages and is kept to a minimum. The layout generator 403 analyzes a combination of a plurality of jobs and imposes images of the plurality of jobs on sheets to fit within the minimum number of sheets. On the other hand, in a case where the imposition in the same column is not prioritized (step S408: NO), the layout generator 403 determines a print layout that straddles the output columns (step S410), and the process ends (return). A specific example of a case where there is no combination of jobs that falls within the search range will be described below.

Returning to FIG. 7, the layout generator 403 executes imposition (step S107). As illustrated in FIG. 13, in a case where there is a combination of jobs that falls within the search range, the layout generator 403 executes imposition of images on a plurality of consecutive sheets based on the combination of jobs to be arranged in the same column, and generates print layouts for all the jobs. On the other hand, in a case where there is no combination of jobs that falls within the search range, either a print layout adjusted to avoid straddling the output columns by inserting blank pages, or a print layout that straddles the output columns is generated.

Next, the image forming apparatus prints images on sheets (step S108). The image forming apparatus prints images on sheets based on the print layouts generated by the layout generator 403.

Next, the sheet processing apparatus 500 processes the printed sheets (step S109). The processing processor 520 cuts the printed sheets into two columns along the column direction using a top/bottom slit unit or a gutter cutting slit unit, for example. Furthermore, the processing processor 520 cuts the printed sheets into three rows along the row direction using the CD cutting unit.

Next, the sheet ejection device 600 ejects the processed sheets (step S110). The sheet ejection device 600 ejects and stacks the first and the second sheets 11 and 12, which have been cut into three rows and two columns by the processing processor 520, onto the sheet stack sections 631 and 632, respectively.

As described above, in the process of the flowchart illustrated in FIG. 7, the job acquirer 401 acquires a plurality of print jobs, and the job analyzer 402 analyzes the plurality of print jobs to acquire information on the sheet size, the print images, the size of the print images, and the number of print pages for each print job. Next, the layout generator 403 acquires the various kinds of settings and the output-column-number information, and determines an imposition layout per sheet, based on the various kinds of settings and the output-column-number information, and the information acquired by the job analyzer 402. Furthermore, the layout generator 403 determines a combination of jobs to be arranged in the same column, and executes imposition based on the determined combination of jobs. The layout generator 403 generates print layouts for the plurality of jobs in which the images of different print jobs are imposed in the respective columns.

### Another Example of Case Where Images of the Same Job can be Imposed on the Expected Number of Sheets Without Straddling Output Columns

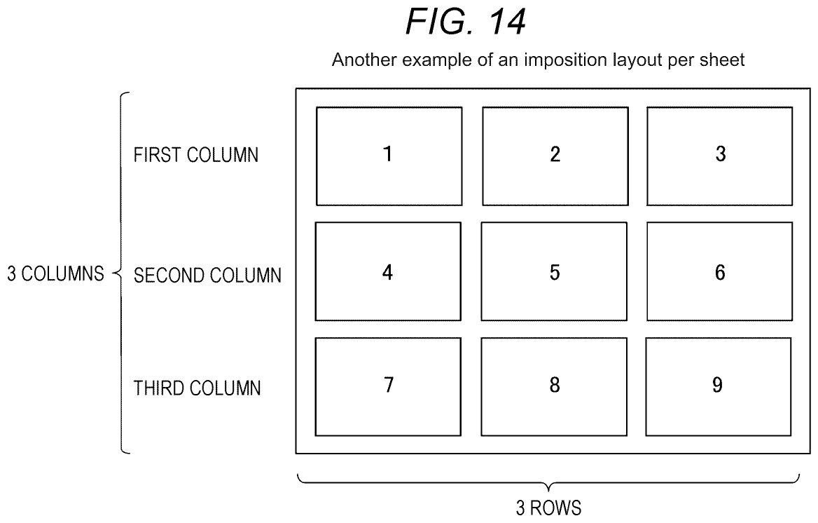

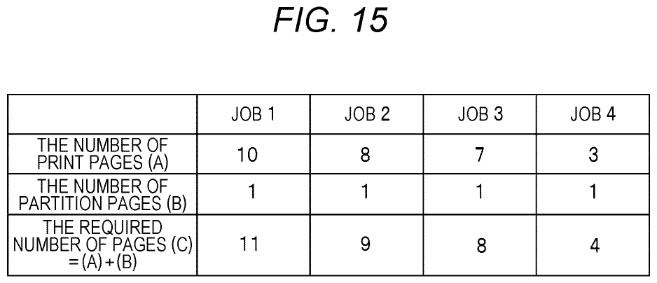

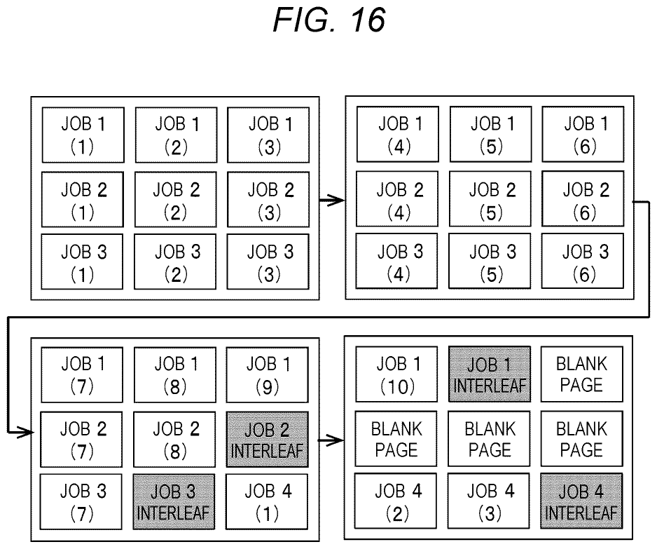

FIG. 14 is a schematic diagram illustrating another example of an imposition layout per sheet, and FIG. 15 is a table summarizing the number of print pages (A), the number of partition pages (B), and the required number of pages (C) for each job. FIG. 16 is a schematic diagram illustrating print layouts generated by the print layout generation apparatus.

As illustrated in FIG. 14, the layout generator 403 generates an imposition layout per sheet based on the sheet size, the image size, the imposition constraint condition, and the number of output columns (three columns). In the example illustrated in FIG. 14, the number of pages that can be imposed per column on a sheet is 3, so that an imposition layout of images of three rows and three columns is generated. The number of impositions per sheet is as follows: 3×3=9.

The layout generator 403 calculates the reference number of impositions. As illustrated in FIG. 15, the number of print pages of the job 1 is 10, the number of print pages of the job 2 is 8, the number of print pages of the job 3 is 7, and the number of print pages of the job 4 is 3. Thus, in a case where the partition page is inserted in each job, by adding 1, which is the number of partition pages (B), to the number of print pages (A) of each job, the required number of pages of the job 1 is 11, the required number of pages of the job 2 is 9, the required number of pages of the job 3 is 8, and the required number of pages of the job 4 is 4. Furthermore, the sum of the required number of pages (C) for all the print jobs, that is, the total number of pages, is 32 and the number of output columns is 3, so that by dividing the total number of pages by the number of output columns, the reference number of impositions results in 10.7.

The expected number of sheets is then calculated by dividing the total number of pages by the number of impositions per sheet, as follows: 32÷9≈3.56. Accordingly, the expected number of sheets is 4.

Since the number of pages that can be imposed per column on a sheet is 3, pages are imposed in multiples of three along each column on a plurality of consecutive sheets. The layout generator 403 determines the imposition search range to be between n times 3 (that is, the 3×n-th sheet) and (n−1) times 3 (that is, the 3×(n−1)-th sheet). The reference number of impositions is 10.7, and the following expression holds. 3×3<10.7<3×4. Thus, the layout generator 403 determines the imposition search range to be 9 to 12.

When a single job or a plurality of jobs is assigned to each column from among the jobs 1 to 4, the layout generator 403 determines, in all the columns, whether the required number of pages of the single job or the sum of the required number of pages for the plurality of jobs falls within the search range. According to FIG. 15, the required number of pages of the job 1 is 11, the required number of pages of the job 2 is 9, and the sum of the required number of pages of the combination of the job 3 and the job 4 is 12. The required number of pages of the job 1 in the first column which is 11, the required number of pages of the job 2 in the second column which is 9, and the sum of the required number of pages of the combination of the job 3 and the job 4 in the third column which is 12, are all within the search range. Thus, the layout generator 403 determines that there is a combination of jobs that falls within the search range. Thus, as illustrated in FIG. 16, the layout generator 403 can impose images of the same job on the expected number of sheets without straddling the output columns.

### Example of Case Where Images of the Same Job Cannot Be Imposed on the Expected Number of Sheets Cannot Without Straddling Output Columns

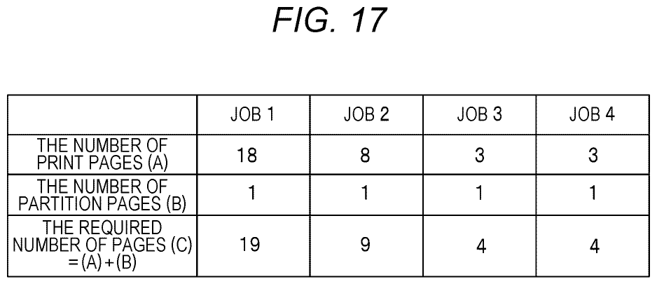

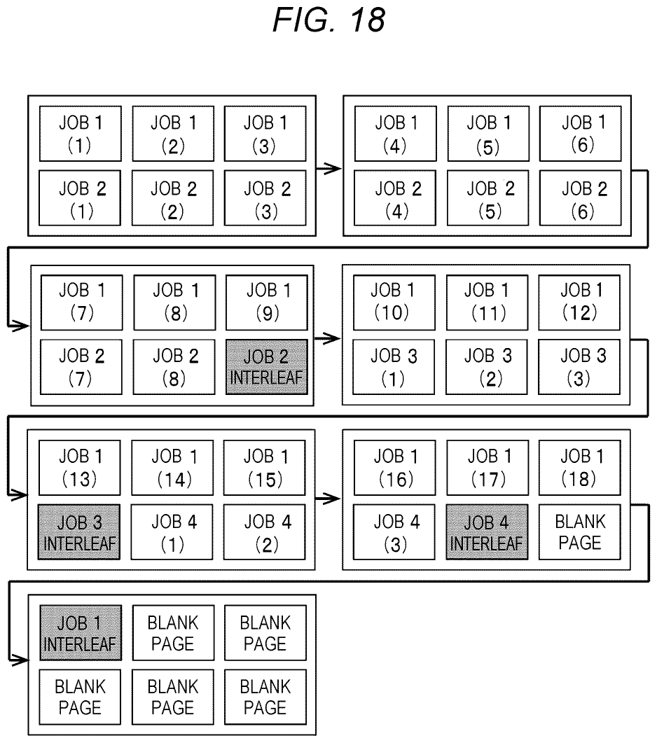

FIG. 17 is a table summarizing the number of print pages (A), the number of partition pages (B), and the required number of pages (C) for each job. FIG. 18 is a schematic diagram illustrating print layouts generated by the print layout generation apparatus.

The imposition layout per sheet is the same as the above-described imposition layout illustrated in FIG. 10. The layout generator 403 generates an imposition layout per sheet based on the sheet size, the image size, the imposition constraint condition, and the number of output columns (two columns). The number of pages that can be imposed per column on a sheet is 3, so that an imposition layout of images of three rows and two columns is generated. The number of impositions per sheet is 6.

The layout generator 403 calculates the reference number of impositions. As illustrated in FIG. 17, the number of print pages of the job 1 is 18, the number of print pages of the job 2 is 8, the number of print pages of the job 3 is 3, and the number of print pages of the job 4 is 3. Thus, by adding 1, which is the number of partition pages (B), to the number of print pages (A) of each job, the required number of pages of the job 1 is 19, the required number of pages of the job 2 is 9, the required number of pages of the job 3 is 4, and the required number of pages of the job 4 is 4. Furthermore, the sum of the required number of pages (C) for all the print jobs, that is, the total number of pages, is 36 and the number of output columns is 2, so that by dividing the total number of pages by the number of output columns, the reference number of impositions results in 18. The expected number of sheets is then calculated as follows: 36÷6=6.

Since the number of pages that can be imposed per column on a sheet is 3, pages are imposed in multiples of three along each column on a plurality of consecutive sheets. The layout generator 403 determines the imposition search range to be between n times 3 (that is, the 3×n-th sheet) and (n−1) times 3 (that is, the 3×(n−1)-th sheet). The reference number of impositions is 18, and the following expression holds. 3×5<18≤3×6. Thus, the layout generator 403 determines the imposition search range to be 15 to 18.

When a single job or a plurality of jobs is assigned to each column from among the jobs 1 to 4, the layout generator 403 determines, in all the columns, whether the required number of pages of the single job or the sum of the required number of pages for the plurality of jobs falls within the search range. The required number of pages of the job 1 is 19, and thus the job 1 alone exceeds the search range. The layout generator 403 determines that there is no combination of jobs that falls within the search range.

As described above, in a case where there is no combination of jobs that falls within the search range, the layout generator 403 determines whether to prioritize the imposition in the same column (step S408). In the case where the imposition in the same column is prioritized (step S408: YES), a combination for imposition in the same column is determined with the minimum possible number of sheets (step S409). As illustrated in FIG. 18, by performing imposition on seven sheets, with the first column assigned to the job 1 and the second column assigned to the jobs 2 to 4, images of the same job can be imposed without straddling the output columns.

On the other hand, in a case where the imposition in the same column is not prioritized (step S408: NO), a print layout that straddles the columns is determined (step S410). By employing print layouts that straddles the output columns, images of all the jobs can be imposed on six sheets, which is one sheet less than a case where images of the same job are imposed without straddling the columns.

According to the print layout generation apparatus of the present embodiment described above, the images of different print jobs are imposed in respective output columns based on the number of print pages of each print job. Therefore, it is possible to prevent or suppress an increase in effort and occurrence of errors in work such as sorting and collating of printed sheets.

As described above, the print layout generation apparatus, the computer-readable storage medium storing the print layout generation program, and the image forming apparatus have been described in the embodiment. However, it is obvious that those skilled in the art can appropriately make addition, modifications, and omissions with respect to the present invention within the scope of the technical idea thereof.

For example, although in the above-described embodiment, the case where the number of output columns is two or three has been described as examples, the number of output columns may be four or more.

In addition, it is also possible to employ a configuration in which the number of columns that can be cut by the processing processor 520 and the number of columns that can be accepted in the sheet ejection device 600 are each set to k columns, and the number of output columns can be set to a plurality of columns smaller than k. For example, by setting each of the number of columns that can be cut by the processing processor 520 and the number of columns that can be accepted in the sheet ejection device 600 to three columns, and the number of output columns to two columns, the sheets cut into two columns can be ejected to the sheet ejection device 600 in parallel in two columns.

In addition, although in the above-described embodiment, the case where the number of pages that can be imposed is three has been described as an example, the number of pages that can be imposed may be one, two, four, or more.

Although the embodiment of the present invention has been described and illustrated in detail, the disclosed embodiment has been created for purposes of illustration and example only, and not limitation. The scope of the present invention should be interpreted by the wording of the accompanying claims.

What is claimed is

1. A print layout generation apparatus comprising:
a hardware processor, wherein
the hardware processor
acquires a plurality of print jobs,
analyzes the plurality of print jobs to acquire the number of print pages of each of the print jobs, and
is capable of imposing images of the print jobs along a first direction of one sheet and a second direction orthogonal to the first direction, and
the hardware processor imposes the images of the print jobs that differ per column along the first direction of the one sheet, side by side in a plurality of lines along the second direction, based on the number of print pages of each of the print jobs.

2. The print layout generation apparatus according to claim 1, wherein
the hardware processor acquires, from the print jobs, a size of sheets and a size of the images to be imposed on the sheets, and imposes the images of the print jobs on the sheets based on the number of print pages, the size of the sheets, and the size of the images to be imposed on the sheets.

3. The print layout generation apparatus according to claim 2, wherein
the hardware processor acquires, in addition to the size of the sheets and the size of the images, at least one of information on a constraint on a distance between the images to be imposed on the sheets and information on the number of output columns in a stack section that stacks, in parallel, the sheets on which the images of the print jobs have been printed, and imposes the images of the print jobs on the sheets based on the information.

4. The print layout generation apparatus according to claim 1, wherein
the hardware processor generates a print layout in which a partition page for identification is inserted before or after each of the print jobs.

5. The print layout generation apparatus according to claim 1, wherein
the hardware processor generates a print layout in which a blank page is inserted between print jobs to prevent images of a same print job from straddling a plurality of columns along the first direction.

6. The print layout generation apparatus according to claim 1, wherein
the hardware processor calculates, based on a sum of the number of print pages for the plurality of print jobs and the number of columns along the first direction, the reference number of impositions per column.

7. The print layout generation apparatus according to claim 6, wherein
the hardware processor determines a search range, within which the reference number of impositions falls, to be between n times and (n-1) times the number of pages that can be imposed per column on a sheet.

8. The print layout generation apparatus according to claim 7, wherein
the hardware processor searches for a combination of the print jobs in which a sum of the number of print pages for the plurality of print jobs falls within the search range, and imposes the images of the print jobs that differ per column based on the combination determined as a result of search.

9. The print layout generation apparatus according to claim 8, wherein
the hardware processor analyzes the combination of the plurality of print jobs, and imposes the images of the plurality of print jobs on the sheets to fit within the minimum number of sheets.

10. The print layout generation apparatus according to claim 8, wherein
the hardware processor is configured to allow a user to select, in a case where there is no combination of the print jobs that falls within the search range, whether to prioritize imposition in a same column for a same print job or to perform imposition across different columns for the same print job.

11. A non-transitory computer-readable storage medium storing a print layout generation program for a computer to execute processing comprising:
acquiring a plurality of print jobs;
analyzing the plurality of print jobs to acquire the number of print pages of each of the print jobs; and
generating a print layout that enables imposition of images of the print jobs along a first direction of one sheet and a second direction orthogonal to the first direction, for the plurality of print jobs in which the images of the print jobs that differ per column along the first direction of the one sheet are imposed side by side in a plurality of lines along the second direction, based on the number of print pages of each of the print jobs.

12. An image forming apparatus comprising:
the print layout generation apparatus according to claim 1; and
an image former that forms the images on the sheets using a print layout generated by the print layout generation apparatus based on the print jobs by an electrophotographic method.

13. The image forming apparatus according to claim 12, further comprising:
a processing section that divides the sheets into a plurality of pieces by cutting the sheets on which the images of the print jobs are formed along the first direction.

14. The image forming apparatus according to claim 13, further comprising:
a conveyor capable of conveying the sheets divided by the processing section in parallel along the first direction.

15. The image forming apparatus according to claim 14, further comprising:
a stack section capable of stacking, in parallel, the sheets conveyed by the conveyor.

16. The image forming apparatus according to claim 13, wherein
the processing section includes a slitter that cuts a sheet by rubbing an upper rotary blade and a lower rotary blade against each other.

17. The image forming apparatus according to claim 12, wherein output sizes among the plurality of print jobs are all identical.
